(19) United States
(12) Patent Application Publication
(10) Pub. No.: US 2021/0380165 A1
(43) Pub. Date: Dec. 9, 2021

(54) OMNIDIRECTIONAL VEHICLE

(71) Applicant: RAYMOND CHAO, Lake Forest, CA (US)

(72) Inventor: RAYMOND CHAO, Lake Forest, CA (US)

(21) Appl. No.: 17/198,227

(22) Filed: Mar. 10, 2021

Related U.S. Application Data
(60) Provisional application No. 63/035,826, filed on Jun. 8, 2020.
(60) Provisional application No. 63/035,941, filed on Jun. 8, 2020.

(51) Int. Cl. B62D 7/15; B62D 6/00

(52) U.S. Cl. CPC B62D 7/1509; B62D 7/1581; B62D 6/002

(57) ABSTRACT

A vehicle with omnidirectional movement is provided. The vehicle is able to move in three degrees of freedom, including forward, backward, sideways and rotating around the center of the vehicle. Methods of controlling said vehicle said vehicle is also provided. The methods control the movement of the vehicle in an omnidirectional manner by utilizing wheel, tire, suspension, driveshafts, and steering components of a conventional automobile.

### CLAIM OF BENEFIT TO PRIOR APPLICATIONS

This application claims the benefit of U.S. provisional application No. 63/035,826, filed on Jun. 8, 2020, titled “Sideways Moving Vehicles”. This application also claims the benefit of U.S. provisional application No. 63/035,941, filed on Jun. 8, 2020, titled “Omni-Directional Moving Vehicle”. All the above are hereby incorporated by reference.

### BACKGROUND

### Technical Field

The present invention relates in general to vehicles and in particular to automobile vehicles that are also omnidirectional vehicles, which are vehicles capable in moving in any direction with 3 degrees of freedom. The 3 degrees of freedom are the forward and backward directions (y axis), the left and right sideways directions (x axis), the rotate in place clockwise and counterclockwise directions (z axis), and any combination thereof.

### Description of the Related Arts

Though automobile vehicles differ in design and construction in many ways, almost all contemporary automobiles utilize standard components such as wheels, tires, brakes, suspensions, driveshafts, and steering. Standard wheels are wheels that can be mounted on vehicles that can use standard tires. Standard tires are typically steel-belted radial tubeless pneumatic tires with vulcanized rubber tread. Standard suspensions are typically coil springs, leaf springs, or torsion bars, used in conjunction with adaptive, non-adaptive, active or passive dampers to connect the wheel spindle to the body of the vehicle. Example of standard steering suspensions include struts and double wishbone suspensions. Standard driveshafts are single or multi-piece shafts typically having splined ends that deliver power from the drivetrain to standard wheels through the spindle. Standard steering systems are typically power-assisted rack and pinion steering systems that connect the left and right wheels together to the steering wheel.

### SUMMARY

Some embodiments of the disclosure provide a vehicle capable of omnidirectional driving. The vehicle has front wheels and rear wheels that are each constrained by a maximum steering angle that is less than 45 degrees. The two front wheels are steered together, and the two rear wheels are steered together. When the control system indicates a first steering configuration, the front and rear wheels of the vehicle are allowed to rotate in a same rotational direction to move the vehicle forward or backward. When the control system indicates a second steering configuration, the front and rear wheels of the vehicle are powered to respectively rotate in opposite rotational directions to move the vehicle leftward or rightward. When the control system indicates a third steering configuration, the rear wheels are turned in a same direction as the front wheels, and the front and rear wheels are respectively powered to rotate in opposite rotational directions to rotate the vehicle. When the control system indicates a normal driving mode, the front wheels are steered and the rear wheels are not steered; when the control system indicates an omnidirectional driving mode, the front wheels and the rear wheels are steered.

In some embodiments, when the control system indicates the second steering configuration, the rear wheels are turned in an opposite direction as the front wheels, and the vehicle travels leftward or rightward at an angle that is determined by a first steering angle of the front wheels and a second steering angle of the rear wheels, and the control system calculates the first and second steering angles in order to achieve a particular orientation of the vehicle.

In some embodiments, the control system of the vehicle receives a left manual input and a right manual input from a user interface. The left manual input is used to indicate a change of orientation and the right manual input of the control system is used to indicate a direction of travel. In some embodiments, when the right manual input indicates a steering angle that is within a particular steering angle, the rear wheels are steered to turn in a same direction as the front wheels to perform crab steering, and when the right manual input indicates a steering angle that exceeds the particular steering angle, the front and rear wheels are powered to respectively rotate in opposite rotational directions to move the vehicle laterally leftward or rightward.

The preceding Summary is intended to serve as a brief introduction to some embodiments of the disclosure. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a Summary, Detailed Description and the Drawings are provided. Moreover, the claimed subject matter is not to be limited by the illustrative details in the Summary, Detailed Description, and the Drawings, but rather is to be defined by the appended claims, because the claimed subject matter can be embodied in other specific forms without departing from the spirit of the subject matter.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 conceptually illustrates the components of an omnidirectional vehicle.

FIG. 2 illustrates normal turning motion of the omnidirectional vehicle.

FIG. 3 illustrates sideway or lateral motions of the omnidirectional vehicle due to front and rear wheels rotating in opposite directions.

FIG. 4 illustrates diagonal motion of the omnidirectional vehicle.

FIG. 5 illustrates zero radius rotation motion of the omnidirectional vehicle.

FIGS. 6a-b illustrates a joypad that is being used to control the omnidirectional vehicle, consistent with an exemplary embodiment.

FIG. 7 illustrates various input states of the joypad in Mode 1 and their corresponding automobile vehicle responses.

FIG. 8 illustrates using the right joystick to perform four-wheel steering.

FIG. 9 illustrates using the right joystick for sideway or lateral driving.

FIG. 10 illustrates using the left joystick for rotating or changing the orientation of the vehicle.

FIG. 11 illustrates conceptually computer control of the omnidirectional vehicle.

FIG. 12 illustrates mixing inputs from the right and left joysticks when controlling an omnidirectional vehicle.

FIG. 13 illustrates an example of an omnidirectional vehicle being controlled by the mixing system.

FIG. 14 illustrates correction for unwanted clockwise rotation during automatic sideways parking.

FIG. 15 illustrates correction for unwanted lateral movement during automatic sideways parking.

FIG. 16 conceptually illustrates a process 1600 for controlling an omnidirectional vehicle.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

Some embodiments of the disclosure provide an automobile vehicle which is capable of omnidirectional movement (also referred to as an omnidirectional vehicle.) The omnidirectional vehicle is capable of moving in all directions with 3 degrees of freedom. In some embodiments, the omnidirectional vehicle is constructed by using standard automobile components including wheels, tires, suspensions, driveshafts and steering. In some embodiments, the omnidirectional vehicle has a structural frame and one or more engines and/or motors driving the vehicle via four standard wheels and tires and having standard driveshafts, suspension and steering. The wheels of the omnidirectional vehicle are standard because they are constrained as in a conventional vehicle, in which each wheel can be steered to turn or rotate no more than a certain maximum turning angle that is substantially less than 90 degrees, e.g., 30 degrees or 45 degrees (0 degree being straight ahead). Furthermore, the two front wheels of the vehicle are constrained to rotate in roughly the same angular speed to go forward or backward, and the two rear wheels of the vehicle are constrained to rotate in roughly the same angular speed to go forward or backward.

In some embodiments, the vehicle has two motors, one for the front two wheels and one for the back two wheels. The two motors can be electrical motors, internal combustion engines, or any other types of motors. As such, the front wheels can rotate in the same direction as the rear wheels or in the opposite direction as the rear wheels. For example, the front wheels of the omnidirectional vehicle may rotate to go forward (clockwise when viewed from the right and counterclockwise when viewed from the left) while the rear wheels of the omnidirectional vehicle may rotate to go backward (counterclockwise when viewed from the right and clockwise when left) and vice versa.

The front two wheels are connected to a front steering mechanism that steers the front wheels and the rear two wheels are connected to a rear steering mechanism steers the rear wheels independently of the front wheels. In some of these embodiments, the front steering mechanism is connected to the power assisted steering column and can be controlled directly by the vehicle driver to be steered as a normal automobile or controlled directly by an omnidirectional control computer. The rear steering mechanism is connected to an electric motor and can be controlled directly by the omnidirectional control computer.

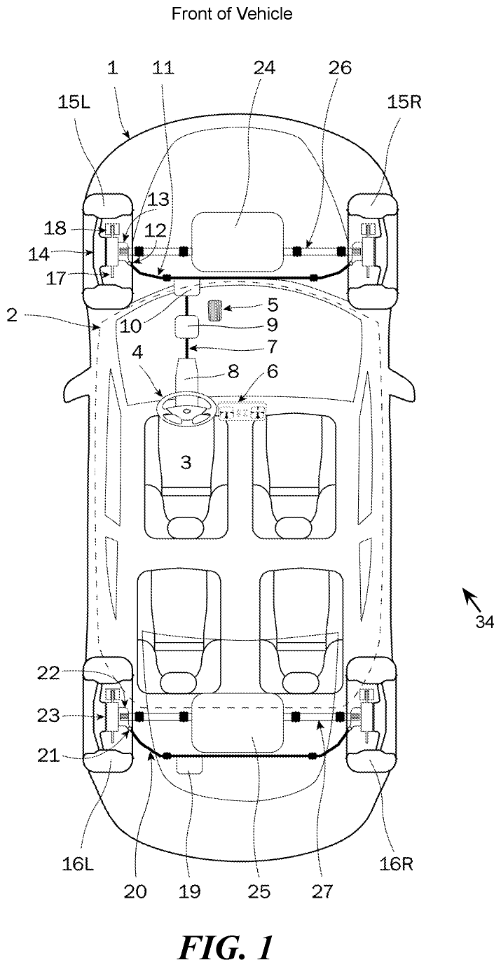

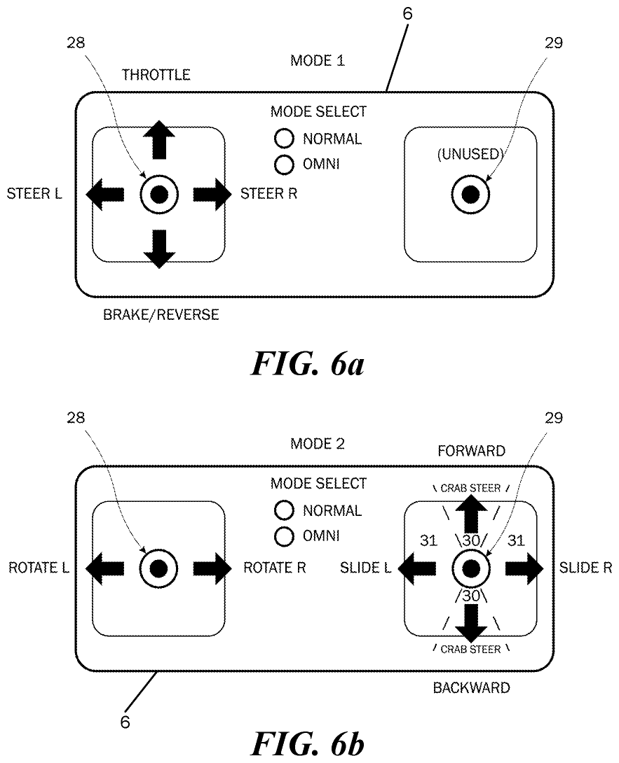

For some embodiments, FIG. 1 conceptually illustrates the components of an omnidirectional vehicle 34. As illustrated, the omnidirectional automobile vehicle 34 has a frame 1 within which is a cabin 2 for accommodating passengers therein. The cabin is provided with a driver's seat 3 which has a steering device. The steering device 4 includes a steering wheel positioned in front of the driver's seat. A throttle pedal 5 is provided in front of the driver's seat on the floor of the cabin that can be pressed with the driver's foot. A control pad with dual multidirectional joysticks (joypad) 6 is provided in the cabin, within reach of the driver such that the automobile can be controlled electronically and remotely. The user or driver may use the joypad 6 to control the vehicle in two different modes of driving, referred to as Mode 1 and Mode 2. In Mode 1 (or normal mode), the joypad may control the vehicle to move as a normal automobile according to known control methodologies including known four-wheel steering. In Mode 2 (or omnidirectional mode), the joypad may control the vehicle 34 to move in any direction and in any orientation with omnidirectional control. Mode 1 and Mode 2 control of the vehicle will be further described below by reference to FIGS. 6-10.

Also, within reach of the driver is provided a mode selection control 6 which allows the driver to select normal driving mode, omnidirectional driving mode, or autonomous driving mode. A steering shaft 7 extends forward integrally from the steering wheel 4 and is able to rotate while being supported by the vehicle frame through a steering column 8. The steering shaft 7 is provided with a steering angle sensor 9 that detects a rotational angle of the steering wheel. A torque sensor 9 is provided that is attached to the steering shaft that detects when rotational force is applied to the steering wheel. An electric motor 10 is provided that attaches to the steering shaft such that the motor can provide additional steering force to assist with driver steering depending on the torque sensor readings or provide complete control over the steering of the front wheels without driver input. The bottom end of the steering shaft is connected to a pinion gear which rotates at the same speed as the steering shaft. A corresponding toothed rack 11 that mates with the pinion gear is provided that moves laterally when the steering pinion is rotated. The end of each side of the rack is connected through a tie rod that is able to pivot via a ball joint 12 when connected to the knuckle spindle arms. The knuckle spindles 13 being supported by the frame through standard suspension components (not shown) are connected to the standard front wheels 14 and tires 15 (including 15L and 15R). When the steering wheel is turned by the driver, the steering rack moves laterally and causes the front knuckles and front wheels and tires to rotate in the corresponding direction of the steering wheel.

An additional (second) electric motor 19 is provided that attaches to a rear pinion gear which rotates as controlled by a provided omnidirectional control unit (OCU) which is a microprocessor that computes and controls motion of the vehicle during omnidirectional driving. A corresponding rear toothed rack 20 that mates with the pinion gear is provided that moves laterally when the steering pinion is rotated. The end of each side of the rear rack is connected through a tie rod that is able to pivot via a ball joint 21 when connected to the rear knuckle spindle arms. The rear knuckle spindles 22 are connected to the standard rear wheels 23 and tires 16 (including 16L and 16R). When the rear steering motor is turned by the OCU, the steering rack moves laterally and causes the rear knuckles and rear wheels to rotate as determined by the OCU. Any further references made to the vehicle wheel implies that each wheel has a mounted tire which rotate in the same direction as one unit.

One or more engines or motors are provided to independently drive the front wheels in the same or opposite direction as the rear wheels. In some embodiments, there are two motors, a front motor 24 which drives the front two wheels (15L and 15R) and a rear motor 25 which drives the rear two wheels (16L and 16R). The front motor is connected to the front inverter/converter, which drives the front motor electronically based on signals from the OCU depending on the driver's pedal input or joypad input. Attached to the front motor is the front differential which splits power between the standard front left and right driveshafts 26 depending on road conditions. The front driveshafts 26 connect to the front knuckle spindles to provide power to the front wheels. The rear motor 25 being connected to the rear inverter/converter which drives the rear motor electronically based on signals from the OCU depending on the driver's pedal input or joypad input. Attached to the rear motor is the rear differential which splits power between the standard rear left and right driveshafts 27 depending on road conditions. The rear driveshafts connect to the rear knuckle spindles 22 to provide power to the rear wheels.

### Operations of the Omnidirectional Vehicle

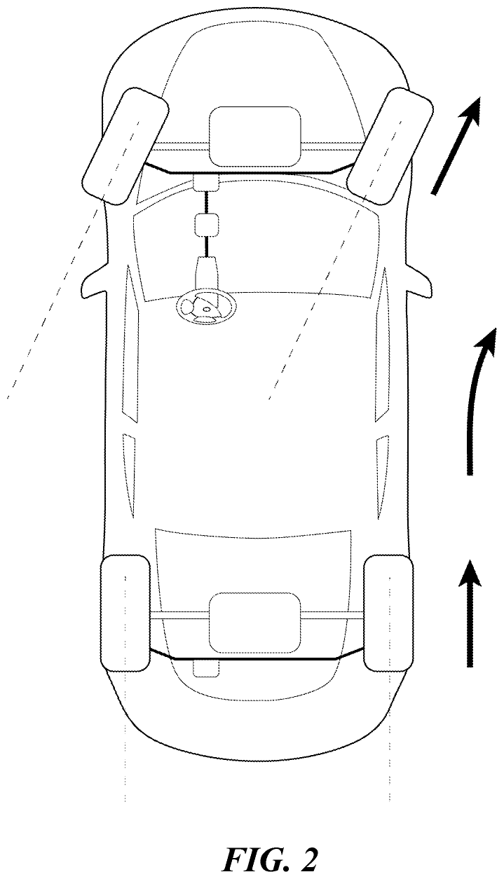

In some embodiments, the front motor 24 and the front wheels 15 can be powered to rotate in either the same direction or the opposite direction as the rear motor 25 and rear wheels 16. When the front wheels are used for steering and the front and rear motors are powered to rotate in the same direction (e.g., front and rear wheels all going forward), the vehicle operates as would a normal automobile vehicle in a normal turning motion. For some embodiments, FIG. 2 illustrates normal turning motion of the omnidirectional vehicle. When the rear wheels are also used for steering, and the front and rear motors are powered to rotate in the same rotational direction, the vehicle operates in a four-wheel steering mode, which gives the vehicle a smaller turning radius or crab-steering ability. The four-wheel steering mode also enables enhanced cornering ability when automatic computer control of the rear wheel steering is used.

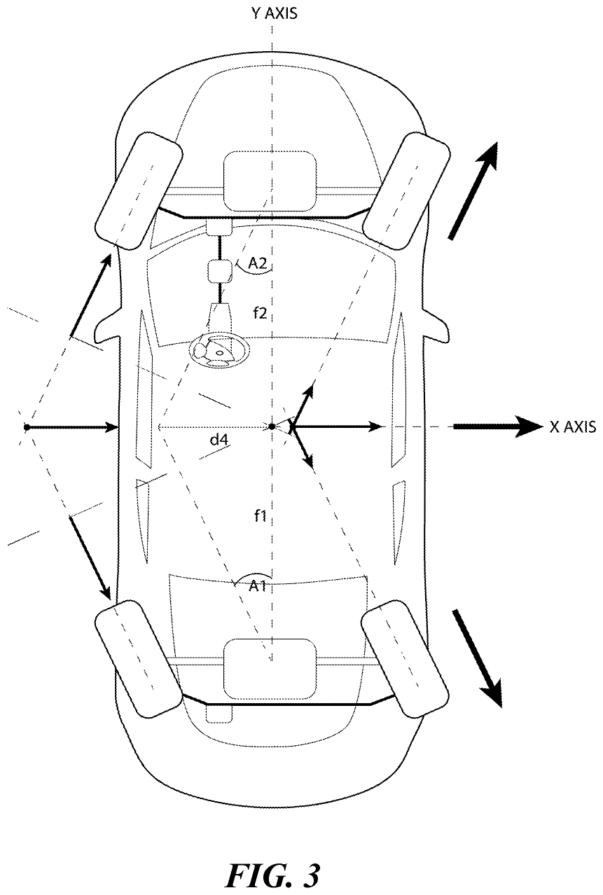

In some embodiments, when the front wheels and rear wheels are steered in the opposite direction (front wheels turning clockwise and rear wheels turning counterclockwise, or front wheels turning counterclockwise and rear wheels turning clockwise), and the motors and the wheels are powered to rotate in opposite directions away from the center of the vehicle (e.g., the front wheels rotate forward while rear wheels rotate backward), the opposing forward and backward forces cancel each other and cause the vehicle to move sideways along the x-axis due to the resulting lateral forces, while maintaining the same the orientation for the vehicle. FIG. 3 illustrates sideway or lateral motions of the omnidirectional vehicle due to front and rear wheels rotating in opposite directions.

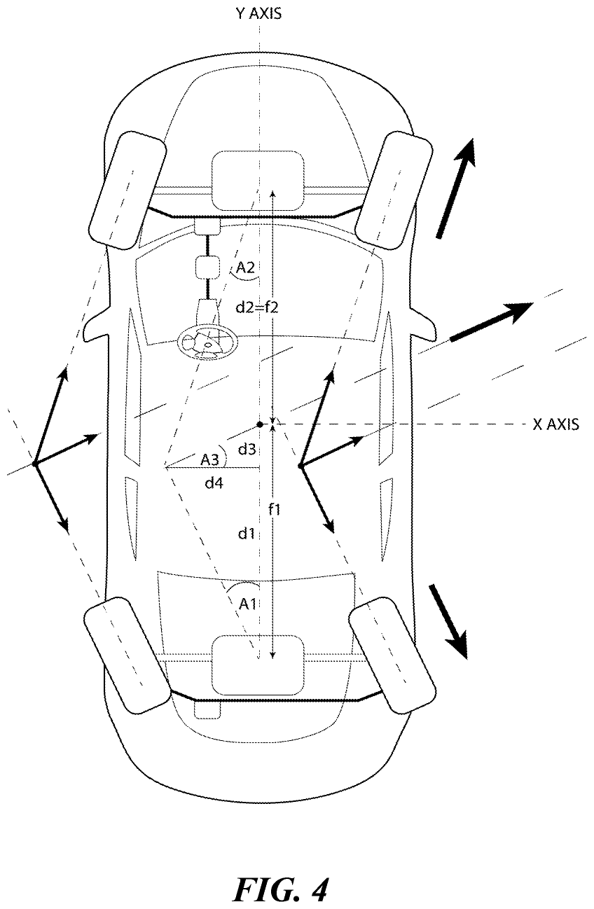

In some embodiments, when the front wheels and rear wheels are steered in the opposite direction and the motors and wheels are powered to rotate in the opposite direction away from the center of the vehicle, the front or rear steering angle can be adjusted such that the torques acting on the center of rotation of the vehicle cancel each other, and vehicle move diagonally at a specified angle due to the resulting lateral forces, while maintaining the same the orientation for the vehicle. FIG. 4 illustrates diagonal motion of the omnidirectional vehicle.

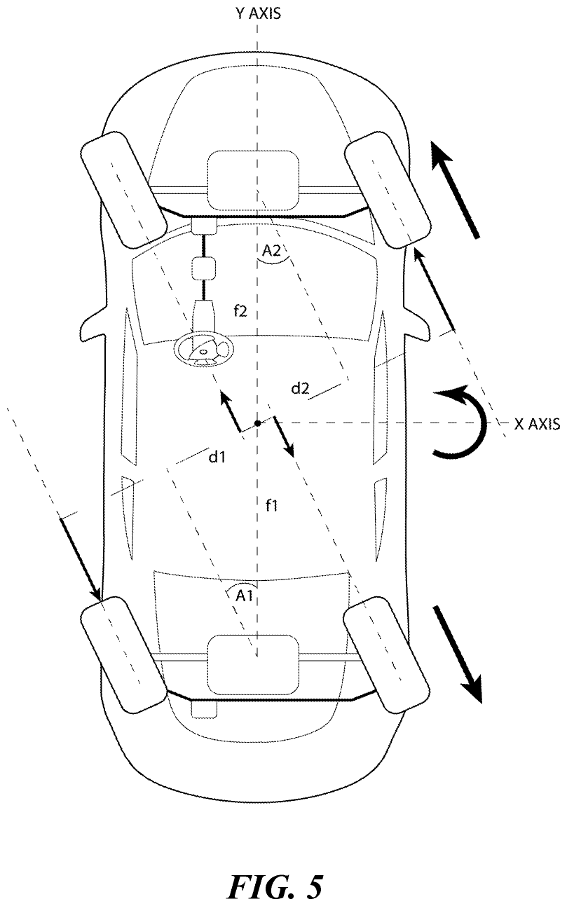

When the front wheels and rear wheels are steered in the same direction (front and rear wheels all turning clockwise, or front and rear wheels all turning counterclockwise) and the motors and wheels are powered to rotate in the opposite direction away from the center of the vehicle, a front wheel and a rear wheel align toward the center of the vehicle, while another front wheel and another rear wheel point away from the center of the vehicle. The front wheels and the rear wheels aligned towards the center of the vehicle will create smaller torques around the center of the vehicle, while the front wheel and the rear wheel pointing further away from the center of the vehicle will create a larger torque around the center of the vehicle due to the larger distance from the vehicle center. This causes the vehicle to rotate in place (zero radius rotation motion about the z-axis.) FIG. 5 illustrates zero radius rotation motion of the omnidirectional vehicle.

By using a combination of front and rear wheel rotation speeds and directions and front and rear steering angles and directions, the vehicle may move and rotate in any direction and/or any orientation as an omnidirectional automobile vehicle.

### Manual Control of the Omnidirectional Vehicle

In addition to or instead of a standard steering wheel, a throttle pedal, and a brake pedal, the omnidirectional vehicle may be controlled by an omnidirectional driving interface (or a supplemental user interface). In some embodiments, the omnidirectional driving interface receives a left manual input (as a first user input) and a right manual input (as a second user input) from the user or driver of the vehicle. The omnidirectional driving interface may be implemented as a physical controller, such as a joypad (e.g., the joypad 6 of FIG. 1) that includes two joysticks for receiving the left and right manual inputs. The omnidirectional driving interface may also be implemented as virtual controller on a touch-screen device having two graphical user interface (GUI) elements for receiving the left and right manual inputs or user gestures. The omnidirectional driving interface may be a single removable unit or a built-in attachment to the steering wheel or other parts of the vehicle. For this document, the term “joypad” is used to refer to the omnidirectional driving interface. The terms “right joystick” and “left joystick” are used to refer to the components of the user interface that respectively receive the left and right manual inputs. FIGS. 6a-b illustrates a joypad that is being used to control the omnidirectional vehicle, consistent with an exemplary embodiment. As illustrated, the joypad 6 has a left joystick 28 and a right joystick 29. The user may use the joypad to control the vehicle in Mode 1 and Mode 2.

For normal driving, or Mode 1, the steering wheel or the joypad can be used to operate the vehicle. FIG. 6a illustrates the joypad when used to operate the omnidirectional vehicle in Mode 1, or normal driving operations. As illustrated, in Mode 1 operation, only the left joystick 28 is used. Pressing the left joystick 28 forward is equivalent to pressing the throttle pedal while the motors engaged in forward motion with the distance the left joystick is moved from the center equal to the amount of throttle. Pressing the left joystick down or backward while the vehicle is moving forward is equivalent to pressing the brake pedal. When the vehicle is stopped, pressing the left joystick down or backward is equivalent to pressing the throttle pedal while the motors are engaged in reverse motion.

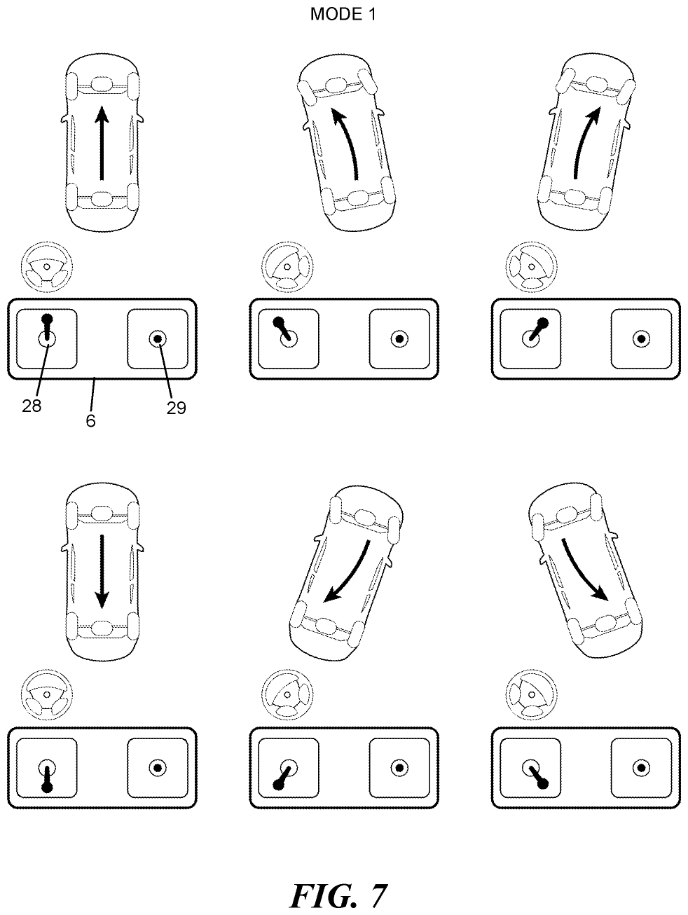

FIG. 7 illustrates various input states of the joypad in Mode 1 and their corresponding automobile vehicle responses. Pressing the left joystick 28 to the left is equivalent to turning the steering wheel leftward or counterclockwise. Pressing the left joystick 28 to the right is equivalent to turning the steering wheel rightward or clockwise. The amount of steering in a particular direction is determined by the distance of the left joystick 28 from the center position in that particular direction. Pressing the left joystick to the upper left corner is equivalent to steering left while pressing the throttle pedal. Releasing the left joystick 28 and centering is equivalent to neutral or applying regenerative braking if applicable. In other words, the joypad in Mode 1 operation is capable of controlling all aspects of a normal driving automobile with one finger.

FIG. 6b illustrates the joypad when used to operate the omnidirectional vehicle in Mode 2, or omnidirectional driving operations. For omnidirectional driving, or Mode 2, the joypad and not the standard steering wheel is used to operate the vehicle in some embodiments. In some embodiments, when the driver selects Mode 2 on the mode selection control, the vehicle responds only to the joypad and not the standard steering wheel. In Mode 2 operation, both right and left joysticks of the joypad are used. The left joystick 28 determines the orientation of the vehicle while the right joystick 29 determines the direction and speed of the movement of the vehicle based on an orientation determined by the left joystick 28.

The range of movement of the right joystick 29 is divided into two types of distinct control regions. When the right joystick 29 is within steering angle 30 (crab steering angle), the omnidirectional vehicle performs crab movement in which front and rear wheels are steered in the same direction and rotate in the same direction (e.g., front and rear wheels all turn clockwise, and front and rear wheels all rotate forward). When the right joystick 29 is within steering angle 31 (lateral steering angle), the omnidirectional vehicle performs sideway or lateral movements as illustrated in FIGS. 3 and 4, i.e., with front and rear wheels steered in opposite direction (e.g., front wheels turn clockwise and rear wheels turn counterclockwise) and rotate in in opposite direction (e.g., front wheels rotating forward and rear wheels rotating backward).

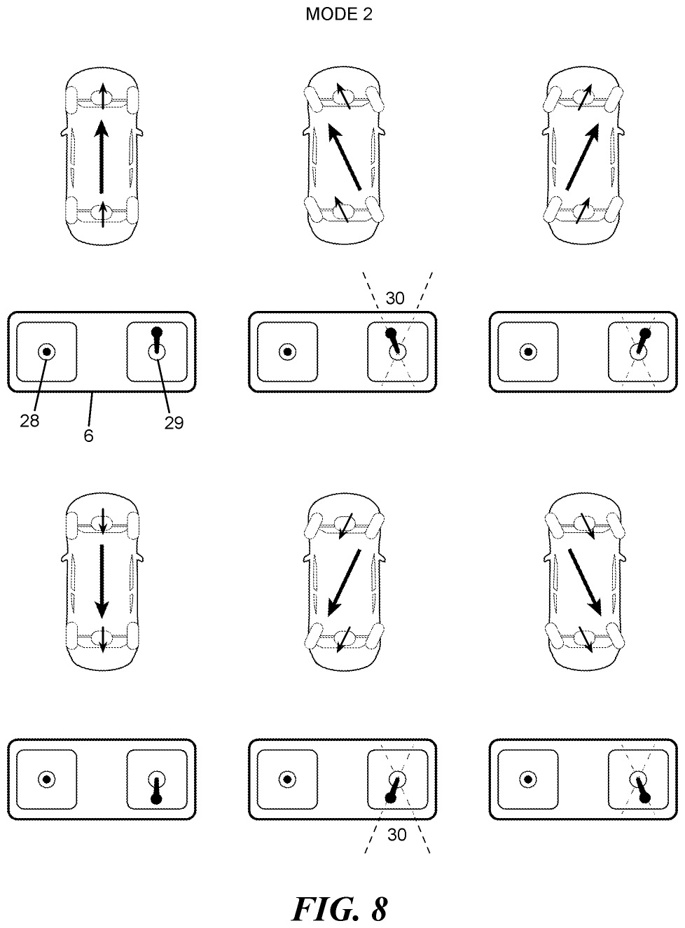

FIGS. 8-10 illustrates various input states of the joypad in Mode 2 and their corresponding automobile vehicle responses.

FIG. 8 illustrates using the right joystick to perform four-wheel steering. During four-wheel steering, the front and rear wheels of the vehicle are rotating to move in the same direction, while the front and rear wheels may be steered to turn in the same direction (crab steering) or opposite direction (tighter turning radius) based on joypad input. As illustrated, pressing the right joystick 29 forward causes the vehicle to move forward with speed determined based on the distance the right joystick is displaced from the center point. Pressing the right joystick 29 down or backward causes the vehicle to move backward with speed determined based on the distance the right joystick is displaced from the center point. Pressing the right joystick 29 diagonally within the crab steering angle 30, the vehicle is crab-steered to moves forward or backward diagonally.

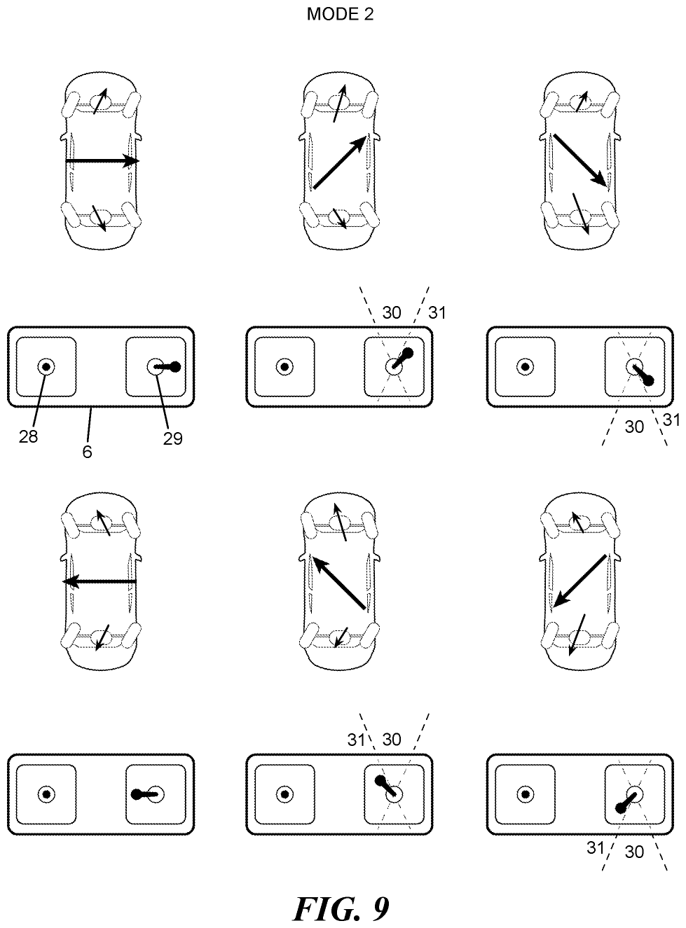

FIG. 9 illustrates using the right joystick for sideway or lateral driving. During sideway or lateral driving, the front and rear wheels of the vehicle are rotating to move in the opposite direction (forward and backward respectively), while the front and rear wheels are steered to turn in opposite direction (e.g., clockwise and counterclockwise respectively). As illustrated, pressing the right joystick 29 to the left causes the vehicle to slide laterally to the left with speed determined based on the distance the right joystick is displaced from the center point. Pressing the right joystick 29 to the right causes the vehicle to slide laterally to the right with speed that is determined based on the distance the right joystick is displaced from the center point. Pressing the right joystick 29 in a diagonal direction (within sideway steering angle 31 and outside of crab steering angle 30) causes the vehicle to move in the same diagonal direction.

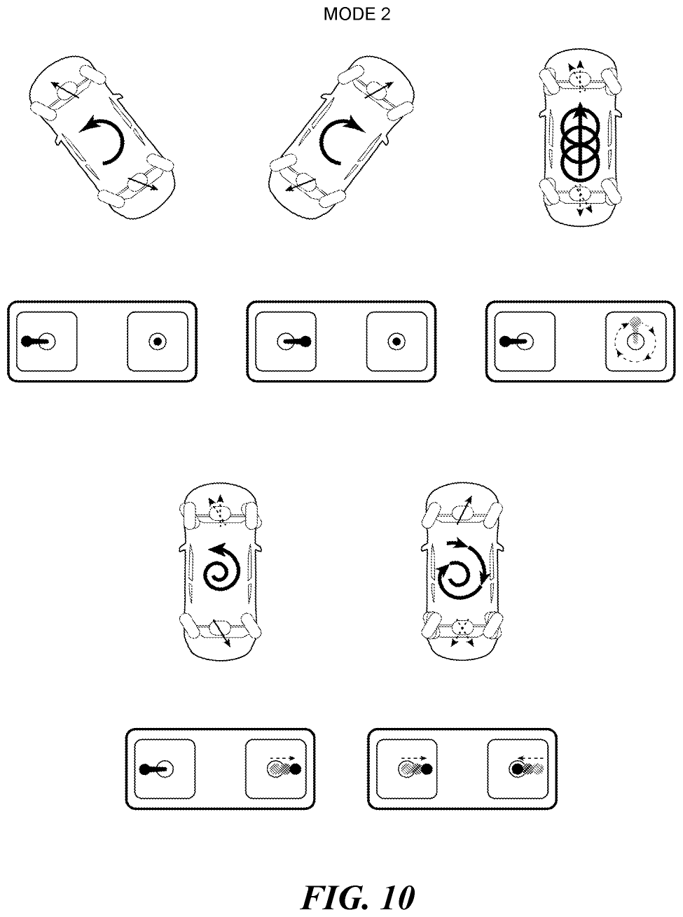

FIG. 10 illustrates using the left joystick for rotating or changing the orientation of the vehicle. As illustrated, pressing the left joystick 28 to the left causes the vehicle to rotate in place counterclockwise. Pressing the left joystick 28 to the right causes the vehicle to rotate in place clockwise. Pressing the left joystick 28 to the right or left while pressing the right joystick 29 in any direction causes the vehicle to rotate but also move in directions specified by the right joystick. If the two joysticks are moved in the same direction, the bottom wheels are altered. If the two joysticks are moved in the opposite direction, the top wheels are altered.

Releasing the right joystick and centering causes the vehicle to stop moving in any direction (any of forward, backward, left, right or diagonal directions.) The movement direction of the vehicle caused by the right joystick 29 is with respect to the current position of the vehicle and not the original position. In other words, the joypad in Mode 2 operation is capable of causing the vehicle to move in any direction in any orientation with omnidirectional control.

### Computer Control of the Omnidirectional Vehicle

In some embodiments, the omnidirectional vehicle may include computer control for various operations and maneuvers, such as autonomous driving, autonomous parking, and orientation control. For example, certain maneuvers, particularly sideways parallel parking, may be performed automatically by an omnidirectional control unit (OCU) to minimize drift due to slope or terrain. Control methodologies can be used to enhance the performance and safety of the vehicle by adding various sensors, including but not limited to accelerometers, gyroscopes, magnetometers, GPS receivers, video cameras, radars, sonars and lidars, as well as mechanisms and electronic devices to determine and limit any unwanted rotation and drifting of the vehicle by varying the front and/or rear steering and the front and/or rear motor speed. In some embodiments, a standard proportional, integral, derivative (PID) control is used to correct the orientation of the vehicle when moving sideways by determining and storing the orientation of the vehicle before a sideways movement. The orientation of the vehicle can be determined absolutely using magnetic compass sensors or relatively by optical flow cameras pointed at the ground. Additionally, the vehicle may drift from 90-degree perpendicular movement and the drift can be determined relatively by optical flow cameras pointed at the ground and the deviation can be corrected using PID control. In some embodiments, an autonomous control unit (ACU) may operate the vehicle in Mode 1, Mode 2 or a combination of the two modes depending on circumstances to implement autonomous driving in the omnidirectional vehicle.

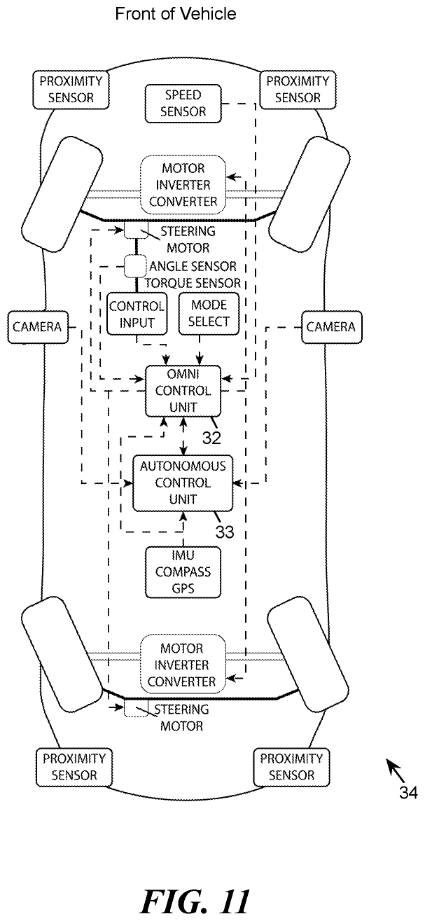

FIG. 11 illustrates conceptually computer control of the omnidirectional vehicle. As illustrated, the omnidirectional vehicle 34 is equipped with an omnidirectional control unit (OCU) 32 and an autonomous control unit (ACU) 33. The OCU 32 controls the operations steering motors and motor inverter converters of the vehicle. The ACU 33 uses inputs from cameras and GPS to generate control for the OCU 32. the vehicle 34 is also equipped with various sensors, including GPS, cameras, speed sensor, proximity sensors, torque sensor, angle sensor, etc., which provide sensory data for the OCU 32 and the ACU 33.

Autonomous driving of the omnidirectional vehicle can be accomplished more easily than in a standard automobile. For a standard automobile, when moving from point A to point B, the ACU 33 unit has to take into account the orientation of the vehicle and compute the optimal path of the vehicle using the steering of the front wheels and the larger turning radius of the standard automobile, and if the orientation at point B is important, the ACU 33 has to use the constraints of a larger turning radius to compute the approach trajectory, steering and final orientation before arriving at point B. When facing a dead end with limited maneuver space, the ACU must compute the optimal three-point turn in potentially small and unknown surroundings while moving forward, backward, turning and stopping multiple times.

On the other hand, for an omnidirectional vehicle, the same point A to point B operation can be accomplished by the ACU rotating the vehicle in place at point A, and driving the vehicle to point B. If the orientation at point B is important, the ACU may rotate the omnidirectional vehicle in place at point B. When facing a dead end with limited maneuvering space, the ACU may rotate the omnidirectional vehicle in place and return in the opposite direction.

In some embodiments, the input from the right joystick 29 may be sent to the OCU 32 to control an angle A3 shown in FIG. 4, relative to the x-axis. The magnitude of the input on the right joystick has a direct relationship to the velocity of the vehicle movement. Given the angle A3, the OCU 32 computes the optimal angle of the steering wheels shown as angle A2 relative to the y-axis in order to cause the vehicle to move in the direction indicated by the joypad input without the vehicle rotating about its center. The steering angle of one side of the vehicle is fixed to the maximum steering angle A1, and the angle A2 may be calculated and varied to correct for undesired lateral or rotational movement. Given that the steering angles of the left and right sides are identical or nearly identical and the steering angles of the front and rear are symmetrical or nearly symmetrical, and the speeds of the left and right wheels are the same or nearly the same, the three-triangle diagram shown in FIG. 4 can be used to solve for the optimal angle of A2 which will create equal torque vectors on both sides of the center of rotation of the vehicle. The angle A2 can be solved according to the following steps:

| Eq. | Operation | Explanation |
|---|---|---|
| 1 | d1* tan(A1) = d4 | from right triangle A1, d1, d4 |
| 2 | (d2 + d3) * tan(A2) = d4 | from right triangle A2, (d2 + |
| | | d3), d4 |
| 3 | d3/tan(A3) = d4 | from right triangle A3, d4, d3 |
| 4 | d1 + d3 = f1 (fixed length), d3 = | |
| | f1 − d1 | |
| 5 | d1 * tan(A1) = d3/tan(A3) | set equation 1 = equation 3 |
| 6 | d1 * tan(A1) = (f1 − d1)/tan(A3) | substitute equation 4 |
| 7 | d1 * tan(A1) * tan(A3) = f1 − d1 | simplify |
| 8 | d1 + (d1 * tan(A1) * tan(A3)) = f1 | simplify |
| 9 | d1 * (1 + tan(A1) * tan(A3)) = f1 | simplify |
| 10 | d1 = f1/(1 + tan(A1) * tan(A3))) | isolated d1, compute d1 |
| 11 | d3 = f1 − d1 | compute d3 |
| 12 | (d2 + d3) * tan(A2) = d3/tan(A3) | set equation 2 = equation 3 |
| 13 | tan(A2) = (d3/tan(A3))/(d2 + d3) | simplify |
| 14 | A2 = tan⁻¹ ((d3/tan(A3))/(d2 + d3)) | simplify |
| 15 | A2 = tan⁻¹ ((d3/tan(A3))/(f2 (fixed | isolate A2, compute A2 |
| | length) + d3)) | |

Referring to the diagram in FIG. 4, the length d1 is the distance from the center of the rear axle to the bottom of the length d4. Length d4 is the distance from the center line of the vehicle to the junction point of the steering angles of the front and rear steering. The length d4 is common to the three triangles shown in the diagram. Length d3 is the distance from the center of rotation of the vehicle to the length d4. Length d2 is the distance from the center of the front axle to the center of rotation of the vehicle which is equal to a fixed length f2 that can be measured on the vehicle. Fixed length f1 is the distance from the center of the rear axle to the center of rotation of the vehicle.

Once the angle A2 is found, the velocity of the front and rear wheels can be determined to match the vector directions to the angle A3 relative to the magnitude of the right joystick 29. The front wheels will be rotating in the forward direction and the rear wheels will be rotating in the reverse direction. If the resultant vector direction matches the vector direction of the angle A3, the vehicle will move in the direction corresponding to the angle A3 with no rotation about its center. If the resultant vector direction does not match the vector direction of the angle A3, there will be a small net rotation (change of orientation) about the center point that can be used to correct unwanted rotation or to perform desired rotation as determined by the left joystick on the joypad. In the case where A3 is 0 or 180 degrees, then d3 becomes 0, and the omnidirectional vehicle moves in a purely lateral direction as shown in FIG. 3. The angle A2 can then be calculated according to the following steps:

| Eq. | Operation | Explanation |
|---|---|---|
| 1 | f1 * tan (A1) = d4 | from right triangle A1, f1, d4 |
| 2 | f2 * tan (A2) = d4 | from right triangle A2, f2, d4 |
| 3 | f1 * tan(A1) = f2 * tan(A2) | set equation 1 = equation 2 |
| 4 | tan(A2) = (f1 * tan(A1))/f2 | simplify |
| 5 | A2 = tan⁻¹ ((f1 * tan(A1))/f2) | isolate A2, compute A2 |

A2=tan⁻1 (f1*tan(A1))/f2) is a fixed value. When the angle A2 is calculated and the velocity of the front and rear wheels are determined to match the vector direction to the angle A3 which is 0 or 180, the vehicle will move sideways as shown in FIG. 3 with a speed that is determined based on the magnitude of the input from the right joystick 29.

In some embodiments, during Mode 2 operations, when the left joystick 28 is moved to the left or right, the vehicle can be rotated or re-oriented about its z-axis or the vehicle's center of rotation. The magnitude of lateral input on the left joystick 28 is a direct relationship to the rate of rotation of the vehicle. A non-zero input on the left joystick 28 will cause maximum steering of the front and rear wheels towards left. The front wheels will be rotating in the forward direction and the rear wheels will be rotating in the reverse direction with rotation speeds determined by the magnitude of the left joystick 28.

Given that the steering angles of the left and right sides are identical or nearly identical and the steering angles of the front and rear are identical or nearly identical, and the speeds of the left and right wheels are assumed to be the same or nearly the same, equal torques can be calculated about the center of rotation of the vehicle based on the dual triangle diagram shown in FIG. 5. According to FIG. 5, the distances d1 and d2 and the corresponding velocities of the front and rear wheels can be determined because fl1and f2 are fixed distances that can be measured and A1 and A2 are set to be equal. Since d1/f1=d2/f2, the relationship of dl and d2 are therefore known and the velocities can be scaled accordingly. The equal torques acting around the center of the vehicle will cause the vehicle to rotate in place with a zero turning radius as shown in FIG. 5 with a rate of rotation determined by the magnitude of the left input joystick.

When rotating in place (FIG. 5), the turning radius of the vehicle is zero. When moving sideways (FIG. 3), the turning radius of the vehicle is infinite. The difference in the arrangement of the vehicle between zero radius and infinite radius is the steering angle of only one pair of wheels. In some embodiments, when the input magnitudes of the right and left joysticks on the joypad are both non-zero, a mixing system is used to determine the resulting steering direction. The mixing system to determine the steering direction is based on the directions of the left and right joysticks of the joypad. The steering angle of the altered wheels are determined by the OCU 32.

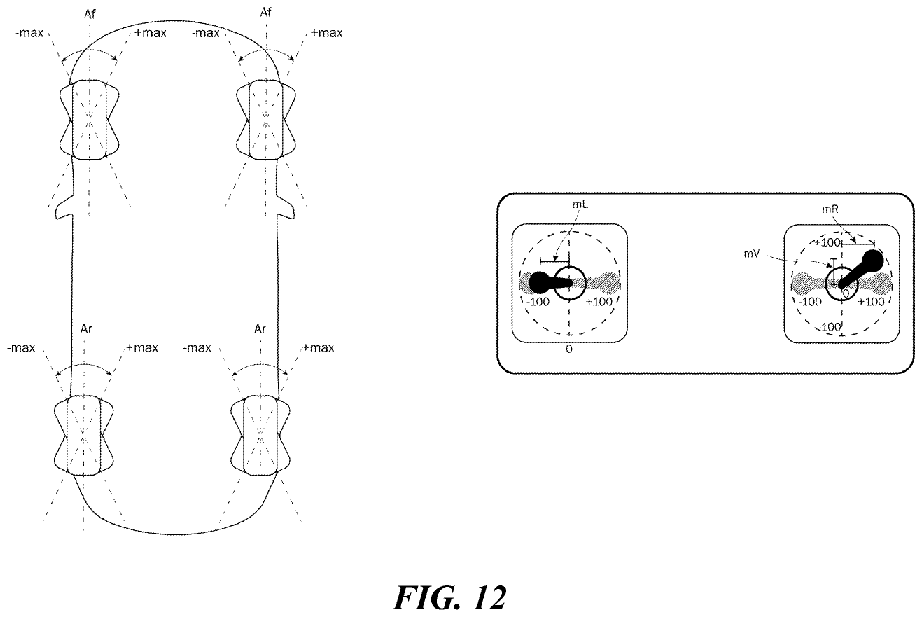

FIG. 12 illustrates mixing inputs from the right and left joysticks when controlling an omnidirectional vehicle. As illustrated, Af is the front steering angle ranging from −max (referring to maximum counter-clockwise rotation) and +max (referring to maximum clockwise rotation). Ar is the rear steering angle having the same range of values. Additionally, mL is the magnitude of the x-axis component of the left joystick input ranging from −100 for all the way left and +100 for all the way right and 0 for in the middle, while mR is the magnitude of the x-axis component of the right joystick 29 with the same range of values. Furthermore:

When mL<0 and mR<0: Ar=max*(|mR|−|mL|)/100, Af=−max

When mL>0 and mR>0: Ar=max*(|mL|−|mR|)/100, Af=max

When mL<0 and mR>0: Af=max*(|mR|−|mL|)/100, Ar=−max

When mL>0 and mR<0: Af=max*(|m51|−|mR|)/100, Ar=max

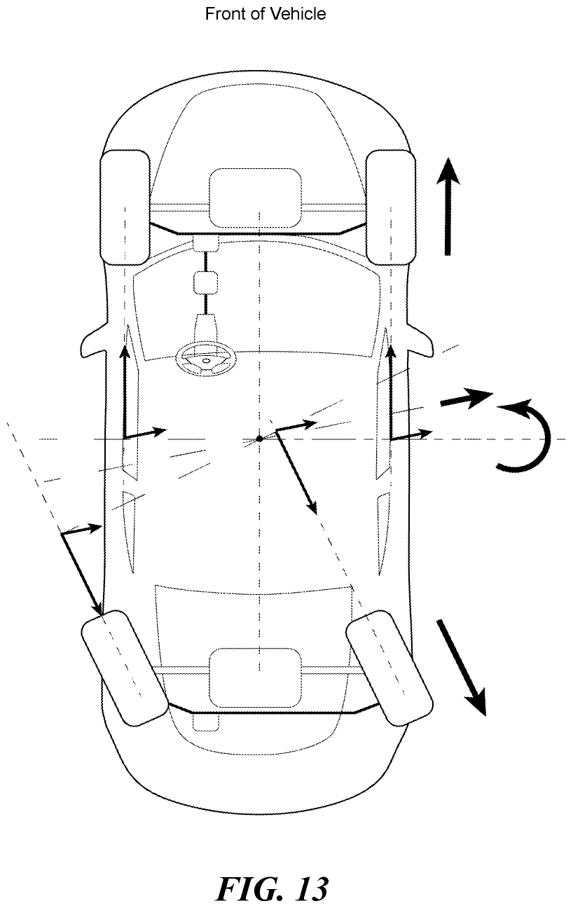

If the y-axis component of the right joystick 29 input is non-zero, the mixing system will increase the speed of wheels as determined by the OCU 32. Specifically, let mV be the magnitude of the y-axis component of the right joystick input ranging from −100 for all the way down and +100 for all the way up and 0 for in the middle. When mV>0 the speed of the front wheels is increased in direct relation to |mV|/100*scaling factor. When mV<0 the speed of the rear wheels is increased in direct relation to |mV|/100* scaling factor. The scaling factor is used to limit the increase to the maximum wheel speed usable in Mode 2 operation and to adjust for vehicle specific geometries and user preference. FIG. 13 illustrates an example of an omnidirectional vehicle being controlled by the mixing system. In the example illustrated, the right joystick input is all the way right (+100) and the left joystick input all the way left (−100).

In some embodiments, the omnidirectional vehicle performs automatic sideways driving and sideways parallel parking. Specifically, the omnidirectional vehicle is equipped with various sensors (e.g., magnetic compass, gyro, accelerometer, GPS, optical flow cameras and proximity sensors) to determine the orientation (or rotation) of the vehicle and to correct for any unwanted lateral or rotational movement due to slope or terrain.

In order to perform automatic sideways driving, a control input or mode select is provided for the driver to select to perform the operation. The OCU 32 will check proximity sensors before and during movement to determine if it is safe to perform the operation. The proximity sensors can be checked to make sure that the vehicle is in the optimal position between two cars. If it is safe to perform the operation and the vehicle is in the optimal position, the OCU will take several magnetic compass readings to ensure that the vehicle is stationary, and that the sensor is stable. The OCU 32 then stores the magnetic compass reading as the heading set point.

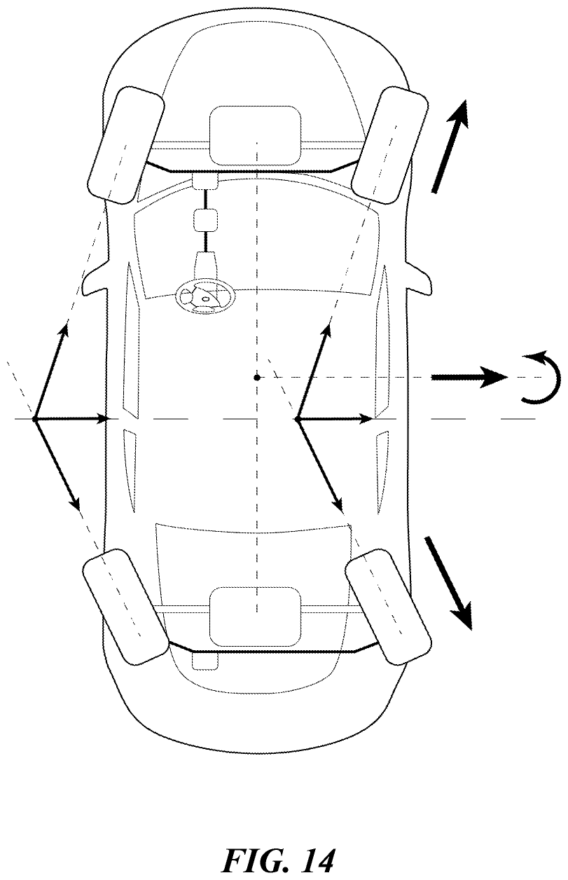

When the vehicle is moving sideways (e.g., FIG. 3), magnetic compass, gyro, accelerometer, GPS, optical flow cameras and proximity sensors can be used to determine the relative and absolute positions of the vehicle and the orientation of the vehicle. The sensor data can be used to create an error signal with which the OCU can correct the unwanted lateral and rotational movement using standard proportional, integral and derivative (PID) control. In the embodiment, the P component (proportional) error of rotation is the set point magnetic compass reading minus the current magnetic compass reading. The I component I (integral) error of rotation is the integral of the P error of rotation which is the running summation of the previous I error of rotation added with the current P error of rotation multiplied by a time constant. The D component (derivative) error of rotation is the Z value of the gyro reading converted in degrees per second. The P, I and D components are each scaled by their tuning coefficients and added together to create an aggregate error of rotation signal. The aggregate error of rotation signal is used by the OCU to compute the correction steering angle for the appropriate wheels as well as the correction wheel rotation speed for the appropriate wheels. FIG. 14 illustrates correction for unwanted clockwise rotation during automatic sideways parking. In the example illustrated, the OCU 32 decreases the steering angle of the front wheels and increase the speed of the rear wheels, which creates a net sideways vector but also a net counterclockwise rotation to counter the unwanted clockwise rotation.

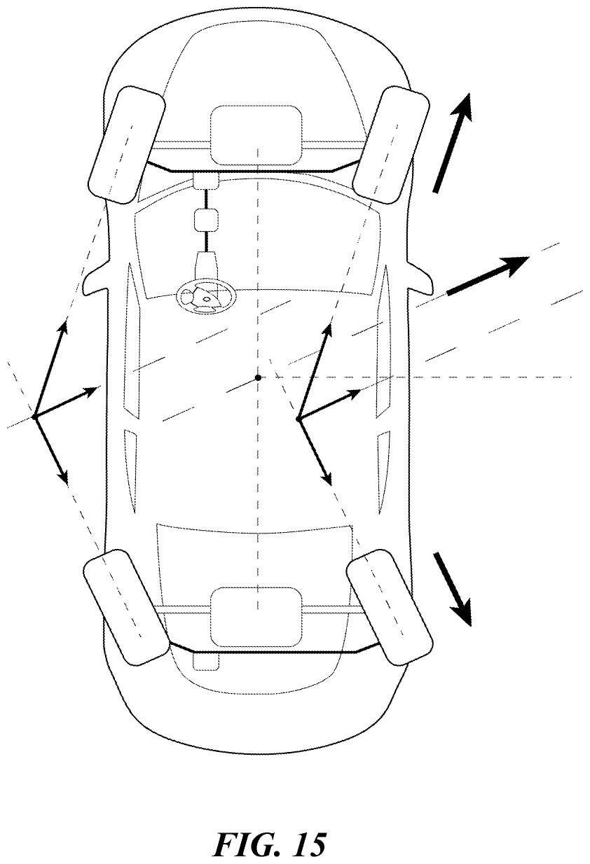

In some embodiments, the P component of lateral error is the optical flow camera reading in the y-axis direction, which indicates that vehicle has moved away from the x direction. The I component of lateral error is the integral of the P component of lateral error which is the running summation of the previous I lateral error added with the current P lateral error multiplied by a time constant. The D component of lateral error is the accelerometer reading in the y-axis direction. The P, I and D components are each scaled by their tuning coefficients and added together to create an aggregate lateral error signal. FIG. 15 illustrates correction for unwanted lateral movement during automatic sideways parking. In the example, the OCU 32 computes the optimal vector laterally opposite to that of the error signal. Proximity sensors and cameras can be used to determine the stopping point of the automatic sideways parking and complete the operation.

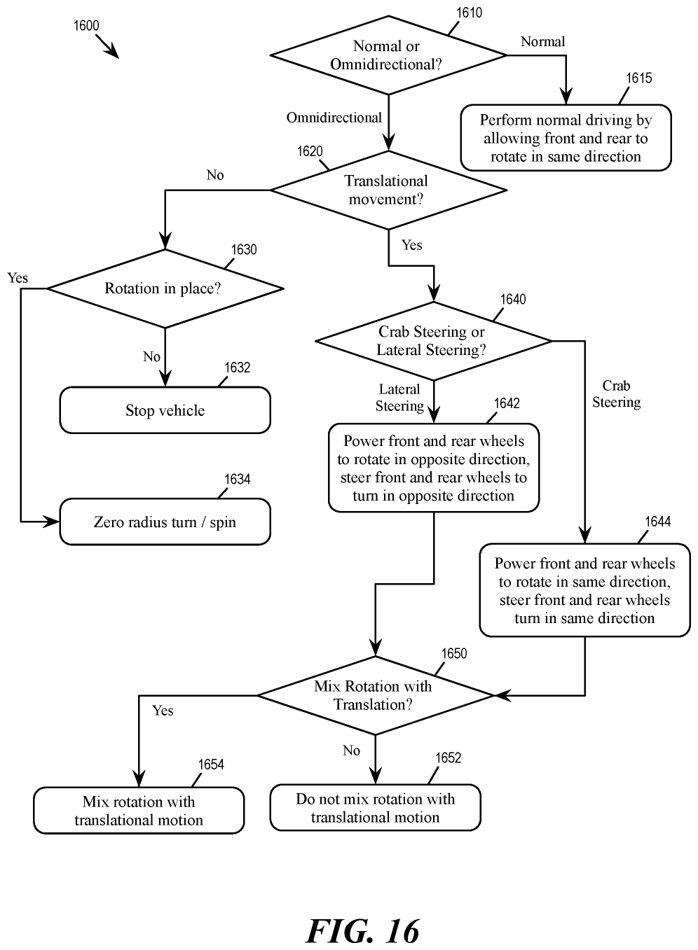

FIG. 16 conceptually illustrates a process 1600 for controlling an omnidirectional vehicle, consistent with an illustrative embodiment. The omnidirectional vehicle can also be said to perform the process 1600. In some embodiments, one or more processing units (e.g., processor) of a computing device implementing a control system of the omnidirectional vehicle (e.g., omnidirectional vehicle 34) perform the process 1600 by executing instructions stored in a computer readable medium. The control system may include the omni control unit (e.g., OCU 32) and the autonomous control unit (e.g., ACU 33). The vehicle has two front wheels and two rear wheels that are each constrained by a maximum steering angle that is less than 45 degrees. The two front wheels are steered together, and the two rear wheels are steered together. In some embodiments, the process 1600 restarts periodically to process any input changes from the joypad. In some embodiments, the process 1600 starts whenever the joypad receives any input changes (e.g., the user or driver moves or gestures the right joystick and/or left joystick to go to a different position or angle).

The vehicle determines (at block 1610) whether to perform normal driving or omnidirectional driving. In some embodiments, the vehicle decides whether to perform normal driving or omnidirectional driving based on whether Mode 1 (normal driving) or Mode 2 (omnidirectional driving) is selected by the driver or user at the joypad. Based on whether the Mode 1 or Mode 2 is selected, and based on inputs from the left and right joysticks of the joypad, the control system may indicate different steering configurations that correspond to different combinations of front/rear wheels steering and rotation directions. If normal driving is selected, the process proceeds to 1615. If omnidirectional driving is selected, the process proceeds to 1620.

At block 1615, the vehicle performs normal driving, i.e., by letting front and rear wheels to move in the same direction and by steering only the front wheels (as described by reference to FIG. 2 above). In some embodiments, the vehicle may also steer the rear wheels to achieve smaller turning radius.

At block 1620, the control system determines whether the vehicle is to move translationally, i.e., to move the vehicle in a manner that moves the center of the vehicle under Mode 2. In some embodiments, under Mode 2, the vehicle moves translationally when the user uses the joypad presses the right joystick away from the center neutral position. If the vehicle is moving translationally, the process proceeds to 1640. Otherwise, the process proceeds to 1630.

The control system determines (at block 1630) whether the vehicle is to rotate in place, i.e., perform zero radius turn. If the vehicle is to rotate in place, the process proceeds to 1634. Otherwise, the vehicle comes (at 1632) to a stop, i.e., not moving translationally or rotationally, e.g., by applying brake or other stopping mechanism.

At block 1634, the vehicle performs zero radius turn or rotate in place. Specifically, the rear wheels are steered to turn in a same direction as the front wheels, and the front wheels and the rear wheels are powered to move in the opposite directions (as described by reference to FIG. 5 above). In some embodiments, whether the vehicle rotate in place clockwise or counterclockwise is determined by user input at the joypad (e.g., at the left joystick).

At block 1640, the control system determines whether the vehicle is to perform crab steering or lateral (sideway steering). In some embodiments, the vehicle performs crab steering if the user indicates a steering angle that is within a crab steering range (e.g., within the maximum steering angle), and performs lateral steering if the user uses the right joystick to indicates a steering angle that is within a lateral steering range (beyond the maximum steering angle.), as described by reference to FIG. 6b above. If the vehicle is to perform crab steering, the process proceeds to 1644. If the vehicle is to perform sideway or lateral steering, the process proceeds to 1642.

At block 1642, the vehicle powers the front and rear wheels to rotate in the opposite direction and steers the front and rear wheels to turn in opposite direction (e.g., front wheels rotate forward and rear wheels rotate backward), in order to perform lateral steering (i.e., to move leftward or rightward without changing orientation.) Lateral steering is described by reference to FIGS. 3 and 4 above. The process then proceeds to 1650.

At block 1644, the vehicle powers the front and rear wheels to rotate in the same direction (e.g., front and rear wheels both rotate forward) and steers the front and rear wheels to turn in same direction, in order to perform crab steering as described by reference to FIG. 8 above. The process then proceeds to 1650.

At block 1650, the control system determines whether to mix rotation motion with translational motion, i.e., whether the vehicle is to rotate or change orientation while performing lateral steering or crab steering. If the vehicle is to change orientation while moving translationally, the process proceeds to 1654. If the vehicle is to move translationally without rotating, the process proceeds to 1652 to continue the translation motion (e.g., crab steering or lateral steering) without applying additional rotational motion.

At block 1654, the control system mixes translational motion with rotational motion by determining a resulting steering direction at the front and rear wheels. In some embodiments, the control system includes a mixing system to determine the steering direction based on the directions of the left and right joysticks of the joypad. The mixing of translational motion with rotational motion is described by reference to FIG. 12 above.

Although the above description of an omnidirectional vehicle is based on a vehicle with two front wheels and two rear wheels, it is understood that an omnidirectional vehicle may have any number (≥1) of front wheels and any number (≥1) rear wheels, and the descriptions of the various embodiments of the present disclosure would still apply.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
steering a vehicle based on a control system, the vehicle comprising two front wheels and two rear wheels that are each constrained by a maximum steering angle that is less than 45 degrees, wherein the two front wheels are steered together, wherein the two rear wheels are steered together;
when the control system indicates a first steering configuration, allowing the front and rear wheels of the vehicle to rotate in a same rotational direction to move the vehicle forward or backward; and
when the control system indicates a second steering configuration, powering the front and rear wheels of the vehicle to respectively rotate in opposite rotational directions to move the vehicle leftward or rightward.

2. The method of claim 1, wherein when the control system indicates a third steering configuration, changing an orientation of the vehicle.

3. The method of claim 1, wherein when the control system indicates a third steering configuration, the rear wheels turn in a same direction as the front wheels, and the front and rear wheels are powered to respectively rotate in opposite rotational directions to rotate the vehicle.

4. The method of claim 1, wherein when the control system indicates the second steering configuration, the vehicle travels leftward or rightward at an angle that is determined by a first steering angle of the front wheels and a second steering angle of the rear wheels.

5. The method of claim 4, wherein the control system calculates the first and second steering angles in order to achieve a particular orientation of the vehicle.

6. The method of claim 1, wherein when the control system indicates the second steering configuration, the rear wheels are turned in an opposite direction as the front wheels.

7. The method of claim 1, wherein:
when the control system indicates a normal driving mode, the front wheels are steered and the rear wheels are not steered; and
when the control system indicates an omnidirectional driving mode, the front wheels and the rear wheels are steered.

8. The method of claim 1, wherein the control system receives a left manual input and a right manual input from a user interface.

9. The method of claim 1, wherein a first manual input of the control system is used to indicate a change of orientation and a second manual input of the control system is used to indicate a direction of travel.

10. The method of claim 9, wherein when the second manual input indicates a steering angle that is within a particular steering angle, the rear wheels are steered to turn in a same direction as the front wheels to perform crab steering.

11. The method of claim 10, wherein when the second manual input indicates a steering angle that exceeds the particular steering angle, the front and rear wheels are powered to respectively rotate in opposite rotational directions to move the vehicle leftward or rightward.

12. A vehicle comprising:
two front wheels and two rear wheels that are each constrained by a maximum steering angle that is less than 45 degrees, wherein the two front wheels are steered together, wherein the two rear wheels are steered together; and
a control system, wherein:
when the control system indicates a first steering configuration, the front and rear wheels of the vehicle are allowed to rotate in a same rotational direction to move the vehicle forward or backward; and
when the control system indicates a second steering configuration, the front and rear wheels of the vehicle are powered to respectively rotate in opposite rotational directions to move the vehicle leftward or rightward.

13. The vehicle of claim 12, wherein when the control system indicates a third steering configuration:
the rear wheels are turned in a same direction as the front wheels; and
the front and rear wheels are powered respectively to rotate in opposite rotational directions to rotate the vehicle.

14. The vehicle of claim 12, wherein when the control system indicates the second steering configuration, the vehicle travels leftward or rightward at an angle that is determined by a first steering angle of the front wheels and a second steering angle of the rear wheels, and the control system calculates the first and second steering angles in order to achieve a particular orientation of the vehicle.

15. The vehicle of claim 12, wherein when the control system indicates the second steering configuration, the rear wheels are turned in an opposite direction as the front wheels.

16. The vehicle of claim 12, wherein:
when the control system indicates a normal driving mode, the front wheels are steered and the rear wheels are not steered; and
when the control system indicates an omnidirectional driving mode, the front wheels and the rear wheels are steered.

17. The vehicle of claim 12, wherein the control system receives a left manual input and a right manual input from a user interface.

18. The vehicle of claim 12, wherein a first manual input of the control system is used to indicate a change of orientation and a second manual input of the control system is used to indicate a direction of travel.

19. The vehicle of claim 18, wherein when the second manual input indicates a steering angle that is within a particular steering angle, the rear wheels are steered to turn in a same direction as the front wheels to perform crab steering.

20. The vehicle of claim 19, wherein when the second manual input indicates a steering angle that exceeds the particular steering angle, the front and rear wheels are powered to respectively rotate in opposite rotational directions to move the vehicle leftward or rightward.
